(19) United States
(12) Patent Application Publication
(10) Pub. No.: US 2015/0135515 A1
(43) Pub. Date: May 21, 2015

(54) CLAMPING APPARATUS AND METHOD

(71) Applicant: MICHAEL COSTEN, Milford, CT (US)

(72) Inventor: MICHAEL COSTEN, Milford, CT (US)

(21) Appl. No.: 14/549,335

(22) Filed: Nov. 20, 2014

Related U.S. Application Data
(60) Provisional application No. 61/906,670, filed on Nov. 20, 2013.

(51) Int. Cl. B25B 5/16; B23Q 17/00; B25B 5/02

(52) U.S. Cl. CPC B25B 5/163; B25B 5/02; B23Q 17/005
USPC 29/559; 269/257; 269/250

(57) ABSTRACT

Disclosed herein is a clamping apparatus that includes a first clamping rail and a second clamping rail. The second clamping rail is curved prior to clamping. The second clamping rail is straightened during clamping such that at least one of a substantially equal and an equal clamping pressure is exerted against at least one object to be clamped across a length of the first and second clamping rails. A method of clamping is further disclosed which includes straightening the second clamping rail and clamping the at least one object between the first clamping rail and the straightened second clamping rail. The method includes providing at least one of a substantially equal and equal pressure across a length of the at least one object with the straightened second clamping rail.

### RELATED MATTERS

This application is a nonprovisional patent application which claims priority to U.S. provisional application No. 61/906,670, filed Nov. 20, 2013, the disclosure of which being herein incorporated by reference to the extent that it is not inconsistent with the original disclosure.

### FIELD OF TECHNOLOGY

The subject matter disclosed herein relates generally to clamps. More particularly, the subject matter relates to a clamp that evenly distributes pressure or force over a length of the clamp.

### BACKGROUND

Existing clamps hold or secure objects tightly together to prevent movement or separation through the application of inward pressure. There are many types of clamps available for many different purposes. Some are temporary, as used to position components while fixing them together; others are intended to be permanent. Most clamps typically include opposing engagement surfaces between which the item to be clamped resides. For example, most C-Clamps include a flat immobile edge and a screw having a flat engagement edge which is rotated to exert more or less pressure on the object being clamped. These clamps exert a great deal of pressure at the points where they contact the object being clamped. However, sometimes it is important to exert an equal amount of pressure over long clamping length. For example, multiple lengths of lumber or elongated fibers, lined up side by side, may need clamping together. Existing clamps do not exert equal pressure along the length of the clamp for equally clamping, for example, multiple objects to be clamped.

Thus, a clamp which evenly distributes pressure or force over a length of the clamp would be well received in the art.

### BRIEF DESCRIPTION

According to one embodiment, a clamping apparatus comprises: a first clamping rail; and a second clamping rail, wherein the second clamping rail is curved prior to clamping; wherein the second clamping rail is straightened during clamping such that at least one of a substantially equal and an equal clamping pressure is exerted against at least one object to be clamped across a length of the first and second clamping rails.

According to another embodiment, a clamping apparatus comprises: a first clamping rail having a first length extending between a first end and a second end; and a second clamping rail having a second length extending between a third end and a fourth end, wherein the second clamping rail is curved prior to clamping such that a midpoint of the second clamping rail is closer to the first clamping rail than the third end and the fourth end of the second clamping rail; wherein the first clamping rail is configured to be straightened during clamping by bringing the third end of the second clamping rail closer to the first end of the first clamping rail and bringing the fourth end of the second clamping rail closer to the second end of the first clamping rail to clamp at least one object between the first clamping rail and the second clamping rail.

According to another embodiment, a method of clamping comprises: providing a first clamping rail; providing a second clamping rail that is curved prior to clamping; straightening the second clamping rail; clamping at least one object between the first clamping rail and the straightened second clamping rail; and providing at least one of a substantially equal and equal pressure across a length of the at least one object with the straightened second clamping rail, wherein the length extends along the first and second clamping rails.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a perspective view of a front side of a clamping apparatus in accordance with one embodiment;

FIG. 2 depicts a perspective view of a back side of the clamping apparatus of FIG. 1 in accordance with one embodiment;

FIG. 3 depicts a perspective view of a clamping screw assembly on one side of the clamping apparatus of FIGS. 1-2 in accordance with one embodiment;

FIG. 4 depicts a cross sectional view of the clamping screw assembly of FIG. 3 in accordance with one embodiment; and

FIG. 5 depicts a perspective view of the clamping apparatus of FIGS. 1-2 after the unfastening of the clamping screw assembly of FIGS. 3-4 in accordance with one embodiment;

FIG. 6 depicts a plurality of the clamping apparatuses prior to clamping a plurality of lumber in accordance with one embodiment;

FIG. 7 depicts the plurality of the clamping apparatuses after clamping the plurality of lumber of FIG. 6 in accordance with one embodiment;

FIG. 8 depicts a perspective view of another clamping apparatus prior to being clamped in accordance with one embodiment;

FIG. 9 depicts a perspective view of the clamping apparatus of FIG. 8 after being clamped in accordance with one embodiment;

FIG. 10 depicts a perspective view of a housing device for a plurality of the clamping apparatus' of FIGS. 8-9 prior to being clamped in accordance with one embodiment;

FIG. 11 depicts a perspective view of another clamping apparatus having a mechanical pressure indicator in accordance with one embodiment;

FIG. 12 depicts a graphical representation of a clamp pressure distribution of a clamp having a standard thickness across its length in accordance with one embodiment; and

FIG. 13 depicts a graphical representation of a clamp pressure distribution of a clamp having a non-uniform thickness across its length in accordance with one embodiment.

### DETAILED DESCRIPTION

A detailed description of the hereinafter described embodiments of the disclosed apparatus and method are presented herein by way of exemplification and not limitation with reference to the Figures.

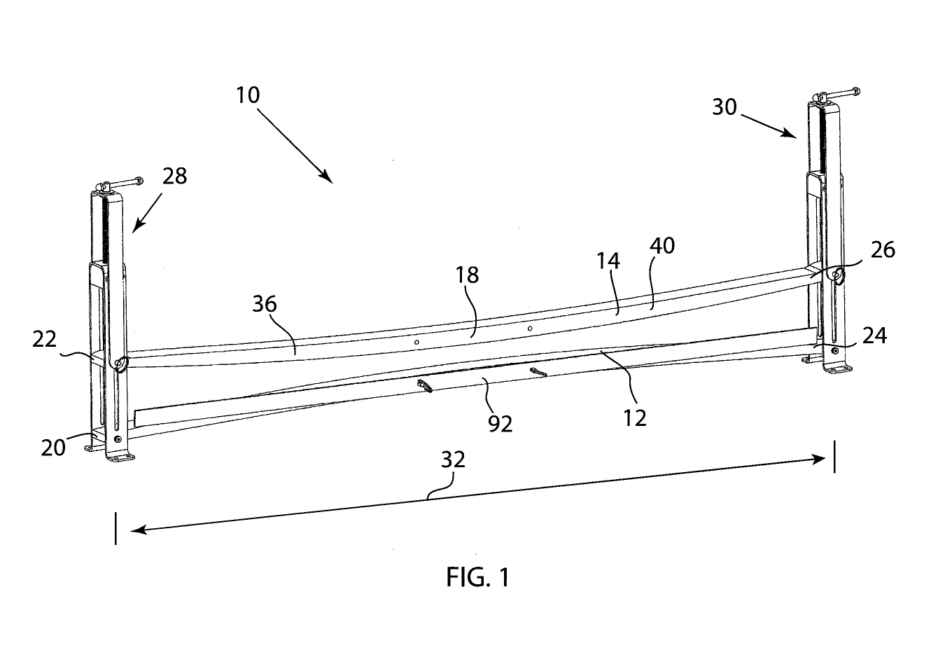

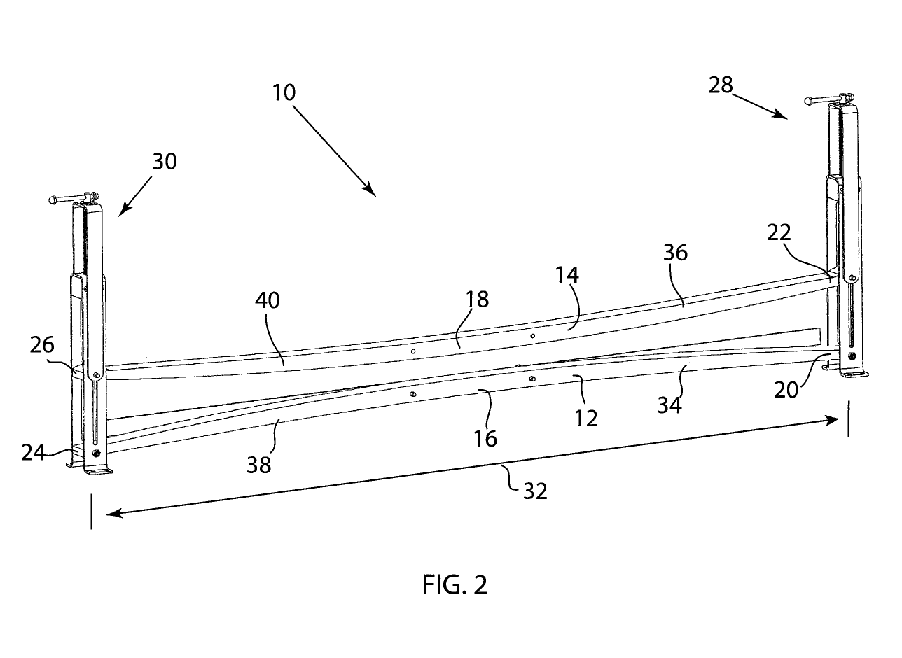

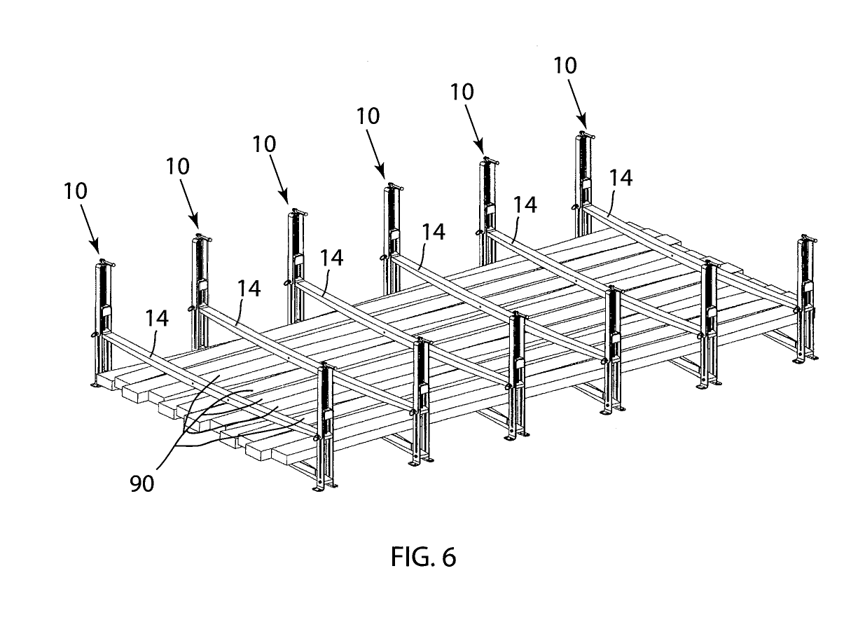

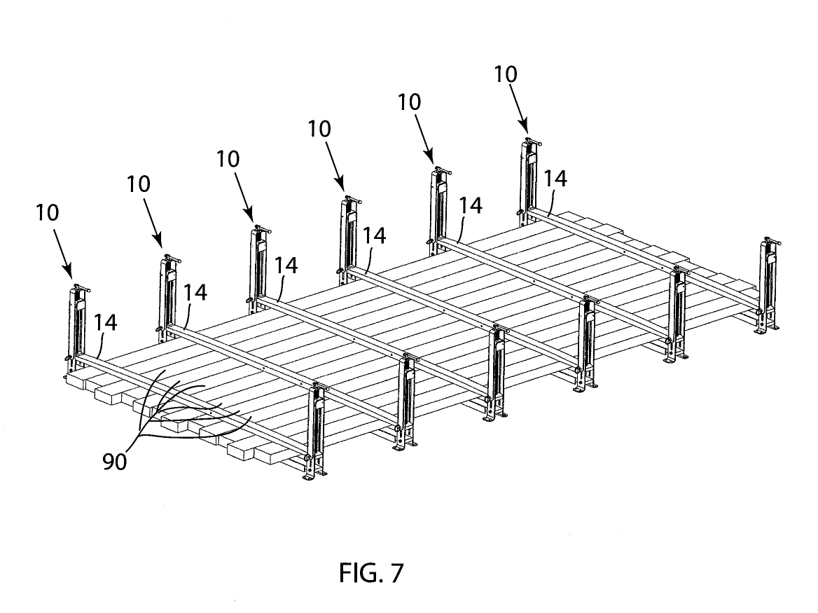

Referring to FIGS. 1-2, a clamping apparatus 10 is shown from a front side (FIG. 1) and back side (FIG. 2). The clamping apparatus 10 includes a first clamping rail 12 having a left end 20, a midpoint 16 and a right end 24, and a second clamping rail 14 having a left end 22, a midpoint 18 and a right end 26. Both the first and second clamping rails 12, 14 are shown being curved prior to clamping such that the midpoints 16, 18 are located closer than the left ends 20, 22 and the right ends 24, 26. The clamping rails 12, 14 may be flexible such that when pressure is brought by a left clamping assembly 28 and a right clamping assembly 30 to bring the left ends 20, 22, and the right ends 24, 26 closer together, the clamping rails 12, 14 flex and straighten. When pushed down at the ends by the left and right clamping assemblies 28, 30, for example, the curve is eventually diminished such that the rails 12, 14 are straightened. Depending on the amount of flexibility or rigidity of the rails 12, 14, the working clamp load may change. For relatively stiff rails 12, 14, the working clamp load may be high. The working clamp load may be a load, or range of loads, which creates a roughly even clamp pressure over a length 32 extending between the left and right clamping assemblies 28, 30. Thus, the clamping apparatus 10 may be designed with a certain amount of proper clamp loading. When the proper clamp loading pressure is applied, the clamping rails 12, 14 are straightened during clamping such that a substantially equal or equal pressure is exerted on at least one object (shown in FIGS. 6-7) to be clamped across a length 28 of the first and second clamping rails 12, 14. Hereinafter “substantially equal” means equal within a twenty percent tolerance range across the length 32. In other embodiments, a five, ten, or fifteen percent tolerance range is contemplated, or any number therebetween. Furthermore, a greater tolerance range than twenty percent is contemplated.

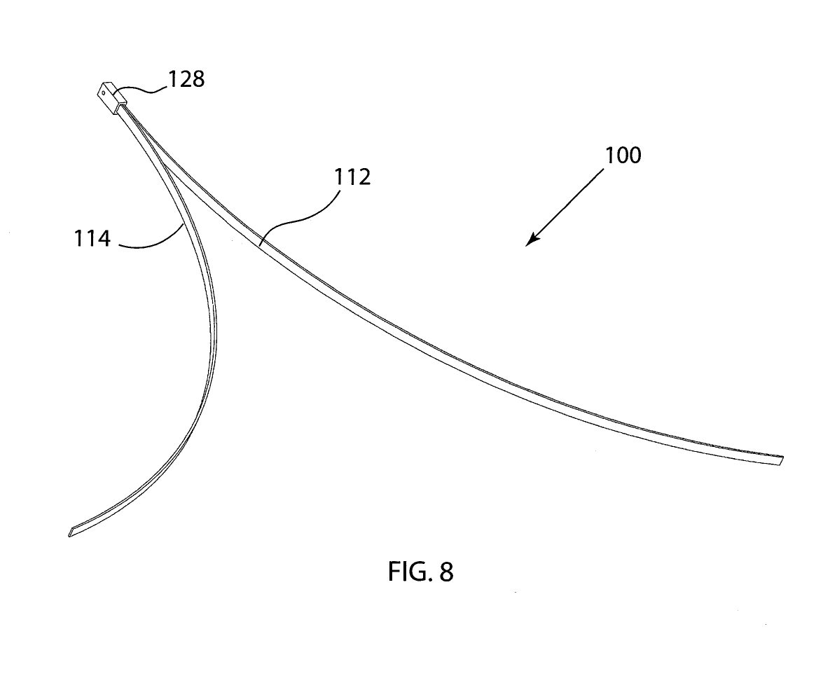

It should be understood that the midpoint 18 of the second clamping rail 14 may not be the point that is structurally closest to the first clamping rail 12 when the clamping apparatus 10 is at a resting state and that other structural configurations are contemplated. Embodiments are contemplated which may include close points that are anywhere along the length. For example, as shown in the embodiment of FIGS. 8-10, one of the ends of the clamping rails may be structurally closest, while the other end may be brought closer together during clamping. Furthermore, the word midpoint may be mean any point along the length of the rails 12, 14 that is a discernable distance from the endpoints 20, 22 and 24, 26.

The first and second clamping rails 12, 14 may be made from a composite material. Alternately, the first and second clamping rails 12, 14 may be made from wood, plastic or metal, or combinations thereof. Whatever the material of the first and second clamping rails 12, 14, the first and second clamping rails 12, 14 should be hard enough to sufficient clamping force on the object to be clamped. Moreover, the material of the clamping rails 12, 14 may be configured to prevent any dual wave buckling whereby the midpoints 16, 18 of the rails 12, 14 have a lower pressure relative to quarter-points 34, 36 and 38, 40. However, it should be understood that this effect may occur if the clamp is overpressured beyond the intended proper clamping pressure. Moreover, equal pressure or substantially equal pressure over the length may not be desirable in some embodiments. For example, custom or tailored pressure distributions are also possible. For example, certain material properties and rail thicknesses may result a clamping pressure distribution over the length 32 of the rails 12, 14 which are unequal. For example, objects located between the rails 12, 14 may experience more pressure on one side than the other. A wavelike pressure distribution across the length 32 is also contemplated, as described hereinabove.

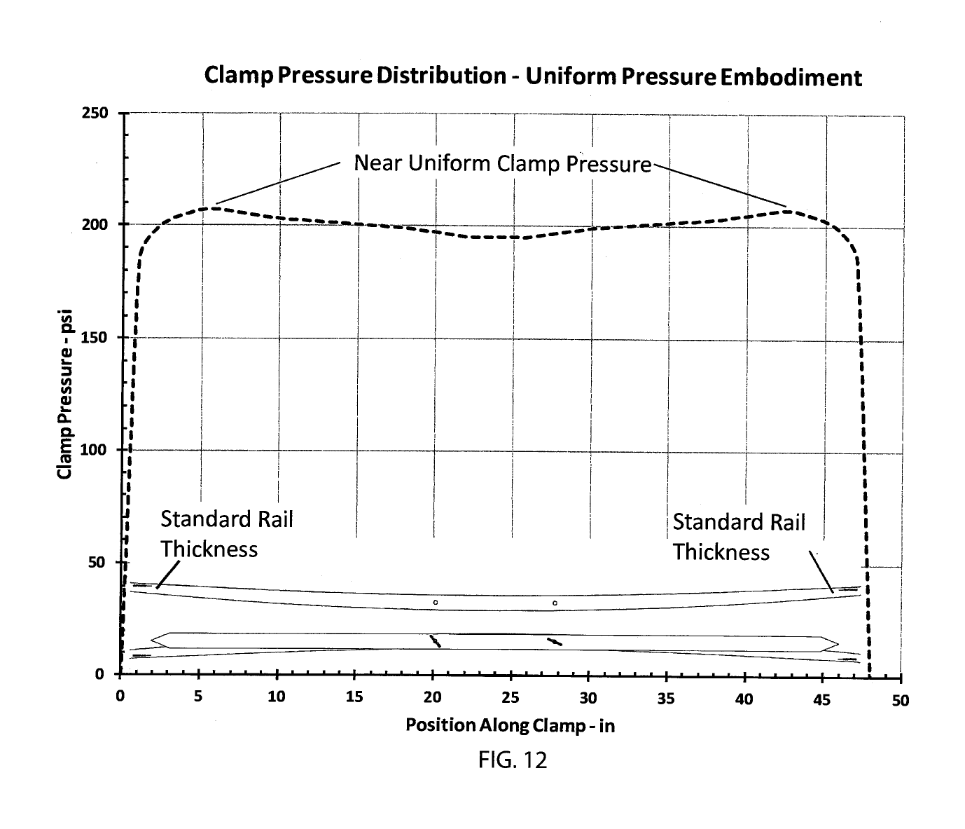

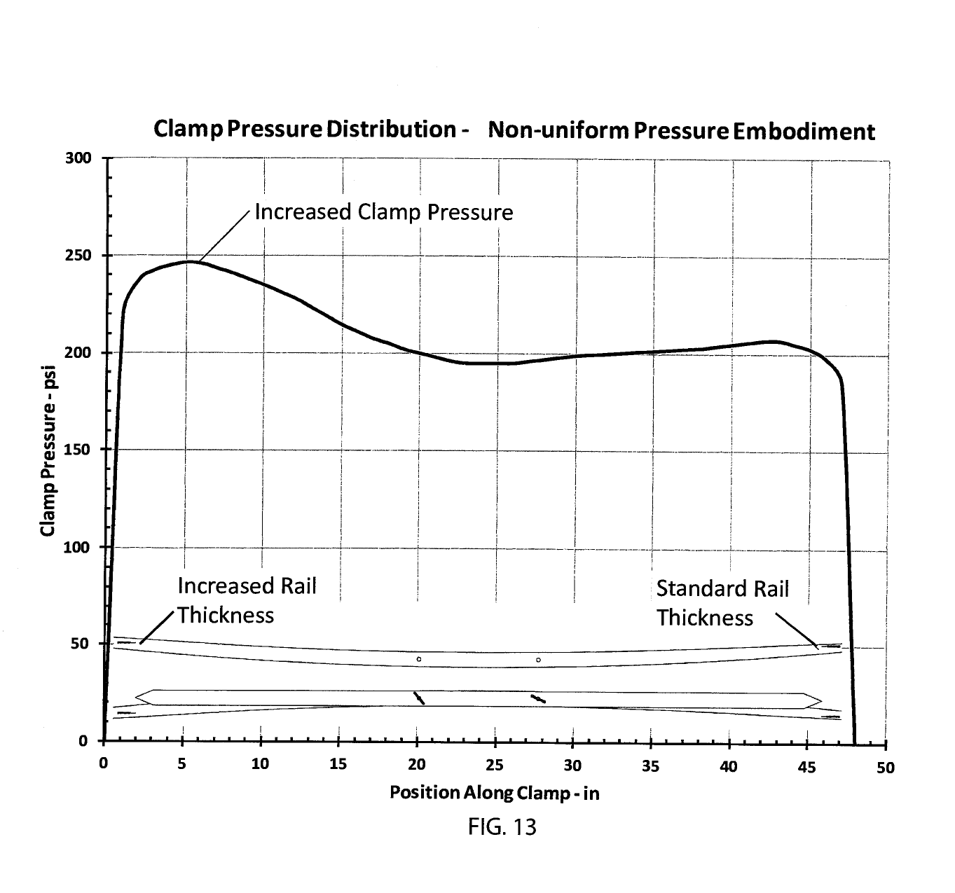

For example, referring to FIG. 12, two rails are shown that both have a standard thickness. These rails are shown to generate a relatively uniform pressure distribution across the length of the rails. This relatively uniform pressure distribution may be considered equal or substantially equal within the meaning of the above-described definition, considering the peaks and valleys of the pressure distribution are within a 10% difference (i.e. having a 207 psi maximum and a 193 psi minimum). Alternatively, as shown in FIG. 13, using a thicker rail on one side (the left side of the graph) may result in increased pressure across this portion of the length of the rails relative to the pressure across the other side having a standard rail thickness. It should be understood that increasing rail thickness in this way may increase the clamp pressure across that portion of the rail. Thus, rails with varying thicknesses across the length are contemplated for creating whatever pressure distribution is desired.

To ensure that the clamping apparatus 10 is being utilized within the working clamp load range, it may be desirable to include electronic stress detectors (not shown) within the rails 12, 14 to determine the amount of stress being applied by the clamping assemblies 28, 30. Thus, the user could immediately know if the proper load has been achieved, or whether the clamping assemblies 28, 30 need to be tightened even further in order to create the uniform clamp pressure over the entire length of rails 12, 14. In one embodiment, the stress detector may simply be an LED which illuminates when the clamping apparatus 10 is clamped with the proper clamping pressure.

Referring back to FIG. 1, the clamping apparatus 10, a level bar 92 may be provided which also helps to level the two rails 12, 14 during clamping. The level bar 92 may also provide a visual indicator. Further, the level bar 92 may structurally provide a flat surface for laying material prior to clamping. However, the level bar 92 may be located at a vertical position such that it does not get in the way of the rails 12, 14 after clamping.

Moreover, one of the clamping rails may be structurally different than the other. For example, the bottom first clamping rail 12 may be a straight rail and may not be curved as shown in the Figures. In this embodiment, only the top second clamping rail 14 may be configured to straighten when force is applied by the left and right clamping assemblies 28, 30. The bottom first clamping rail 12 may simply be a structurally solid base upon which to rest the object to be clamped. Similarly, the top second clamping rail 14 may be a straight rail and may not be curved.

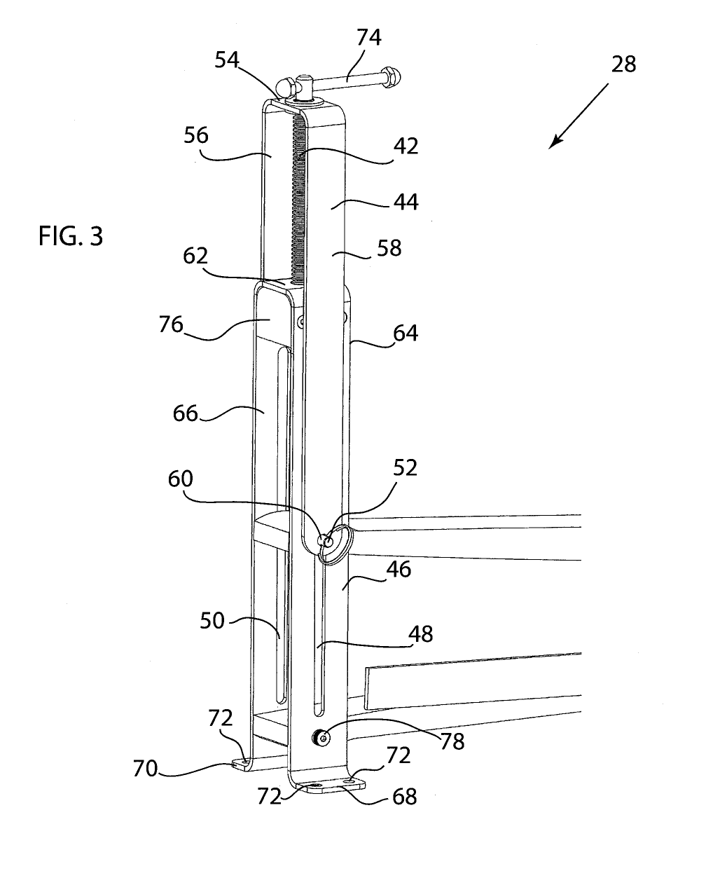

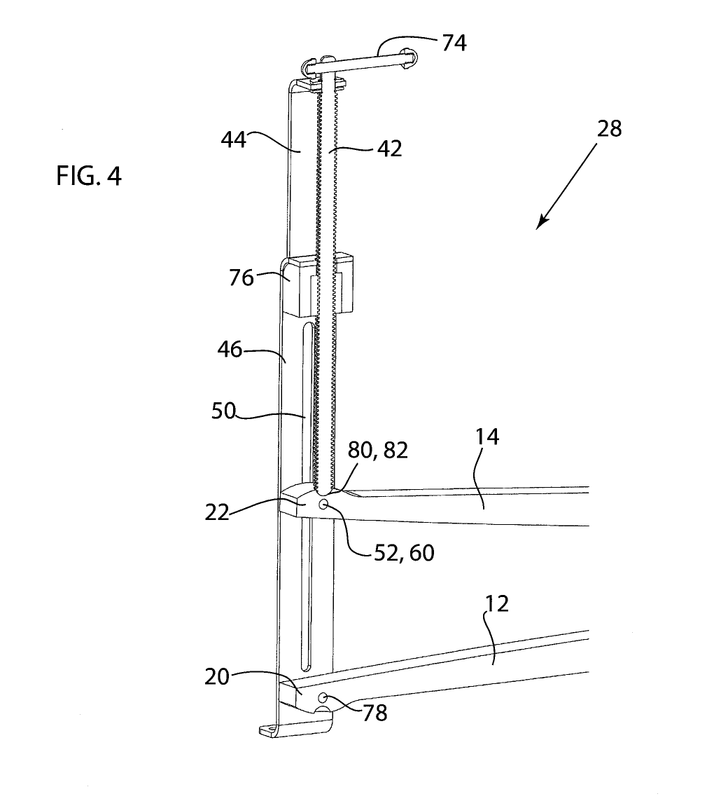

Referring to FIGS. 3-4, the first clamping assembly 28 is shown in greater detail. It should be understood that the second clamping assembly 30 may include the same components as the first clamping assembly 28 shown in FIGS. 3-4. The clamping assemblies 28, 30 may extend vertically relative to the rails 12, 14 which may extend horizontally. The first clamping assembly 28 may include a vertically orientated elongated drive screw 42. The first clamping assembly 28 may further include an outer housing component 44 attached to an end point of the elongated drive screw 42. The first clamp assembly 28 may further include an inner housing component 46. The inner housing component 46 may include corresponding slots 48, 50 extending vertically. A pin 52 also extends through the left end 22 of the second clamp rail 14 in both directions and through both slots 48, 50. Thus, the second rail 14 rides vertically along the slots 48, 50. The outer housing component 44 may be attached to the pin 52 as well. Thus, the vertical movement of the outer housing component 44 and the elongated drive screw 42 with respect to the inner housing component 46 exacts a downward pressure on the left end 22 of the second clamp rail 14. Likewise, the outer housing 44, being attached to the pin 52, may raise the second clamp rail 14 when the pin 52 is rotated in a counterclockwise direction to relieve clamping pressure.

The outer and inner housing components 44, 46 may be u-shaped with elongated side walls. For example, the outer housing component 44 may include a top wall 54, a left side wall 56 and a right side wall 58. The side walls 56, 58 may extend vertically along a substantial length of the first clamping assembly 28. The distal ends of the side walls 56, 58 may include openings 60 for receiving the pin 52. Likewise, the inner housing component 46 may include a top wall 62, a left side wall 64 and a right side wall 66. The left and right side walls 64, 66 may further include outwardly extending base flanges 68, 70. The base flanges 68, 70 may include openings 72 configured to receive bolts for bolting the clamping apparatus 10 to a secure structure, such as a clamping table (not shown). It should be understood that the base flanges 68, 70 may be any structural component, element or assembly configured to secure the clamping apparatus 10 to a surface.

A rotatable pin 74 may be inserted through an opening in the top of the elongated drive screw 42. The rotatable pin 74 may be configured to exact rotational movement on the elongated drive screw 42 in order to vertically move the outer housing component 44 with respect to the inner housing component 46. For example, clockwise rotation of the rotatable pin 74 and elongated drive screw 42 may move the outer housing component 44 downward with respect to the inner housing component 46 in order to tighten the clamp. Counterclockwise rotation of the rotatable pin 74 may similarly release or loosen the clamp. Rotation of the pin 74 may not be configured to cause vertical movement of the pin 74 and elongated drive screw 42 with respect to the outer housing component 44. For example, the pin 74 and the elongated drive screw 42 may be configured to freely rotate about the outer housing component 44 without threadably engaging the outer housing component 44. In other words, the threads of the elongated drive screw 42 may be located below the opening through which the elongated drive screw 42 extends through the top wall 54 of the outer housing component 44.

As shown in the cross sectional view of FIG. 4, housed within the confines of the top wall 62, left side wall 64, and right side wall 66 proximate the top wall 62 of the inner housing component 46 may be a threaded guide housing 76. The threaded guide housing 76 may be a component or assembly that is structurally attached, adhered or otherwise fastened to the inner housing component 46. The threaded guide housing 76 may include female threads through which the elongated drive screw 42 is configured to engage.

In practice, the rotation of the pin 74 may cause the elongated drive screw 42 to movably engage with the inner housing component 46 and drive the elongated drive screw 42 vertically downward into the end 22 of the second clamping rail 14. The elongated drive screw 42 may include, for example, an end 80 that is configured to contact the second clamping rail 14. The second clamping rail 14 may include an indentation 82 configured to receive the end 80 of the elongated drive screw 42.

Still referring to FIGS. 3-4, the first clamping rail 12 may be fixedly attached to the inner housing component 46 with a bolt 78 extending through the inner housing component 46 and the first clamping rail 12. Thus, when the second clamping rail 14 is moved vertically downward, the first clamping rail 12 remains stationary, squeezing an object to be clamped therebetween. It should be understood that a counter spring mechanism (not shown) may further be utilized to retain the second clamping rail 14 above the first clamping rail 12. The counter spring mechanism may, for example, be a spring that attaches to and extends from the threaded guide housing 76 to the left end 22 of the rail 14. For example, the spring may surround the elongated drive screw 42. The spring may put an upward force on the second rail 14 that is relatively easily counteracted by the downward pressure provided by the elongated drive screw 42. This may be configured to retain the second rail 14 in an upwards position to allow for easy introduction of objects to be clamped into the clamp prior to clamping.

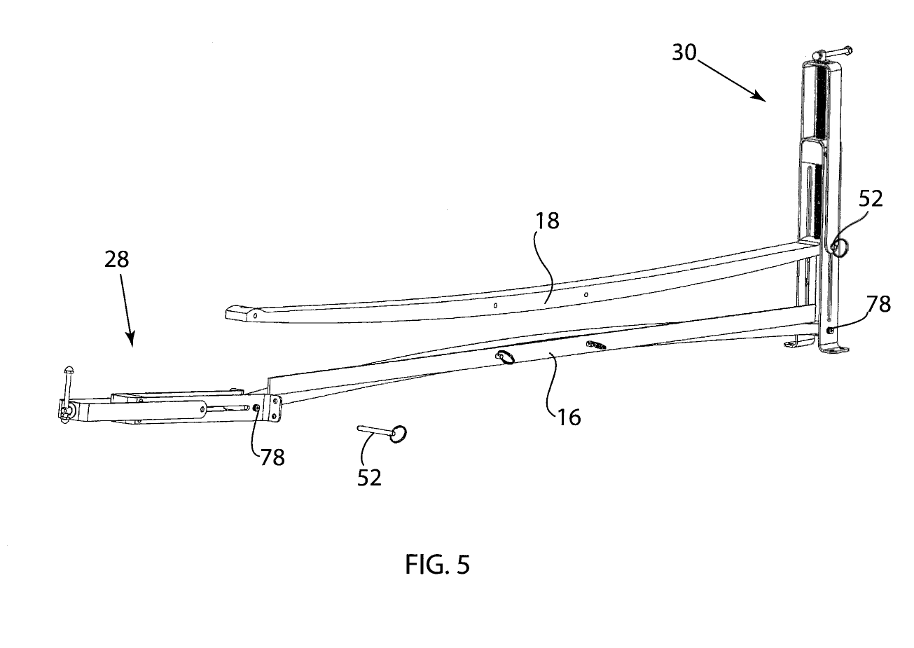

Referring now to FIG. 5, at least one of the first clamping assembly 28 and the second clamping assembly 30 may be at least partially unfastenable from at least one of the first clamping rail 12 and the second clamping rail 14. As shown in FIG. 5, the pin 52 may be removable from the device in order to partially unfasten the first clamping assembly 28 from the clamping apparatus 10. In the embodiment shown, once the pin 52 is removed, the inner housing component 46 may rotate about the bolt 78. The outer housing component 44 may actually be retained in position with respect to the inner housing component 46, despite the removable of the pin 52, by the attachment of elongated drive screw 42 to each of the components 44, 46. In other embodiments, both the first and second clamping assemblies 28, 30 may be at least partially unfastenable. Moreover, the clamping assemblies 28, 30 may be fully unfastenable, for example, with the removal of the bolts 78.

Referring now to FIGS. 6-7, several clamping apparatuses 10 are shown prior to and after clamping a plurality of objects 90, such as lengths of lumber. For example, six different clamping apparatuses 10 are shown which are configured to clamp the lumber 90. As shown in FIG. 6, the lumber 90 may be warped and not vertically straight along their length. However, after clamping, as shown in FIG. 7, the lumber 90 may be straightened. As shown in FIG. 7, the upper clamping rails 14 are each configured to straighten upon clamping to create a straight surface across the lumber 90. This straightness creates an equal or substantially equal pressure across the entire length of each of the clamping rails 14. It should be understood that the lumber 90 could be replaced with any single or plurality of elements that require clamping. The principles of the clamping apparatus 10 may also be scaled down in size, for example, in order to clamp large numbers of hair sized strands, for example.

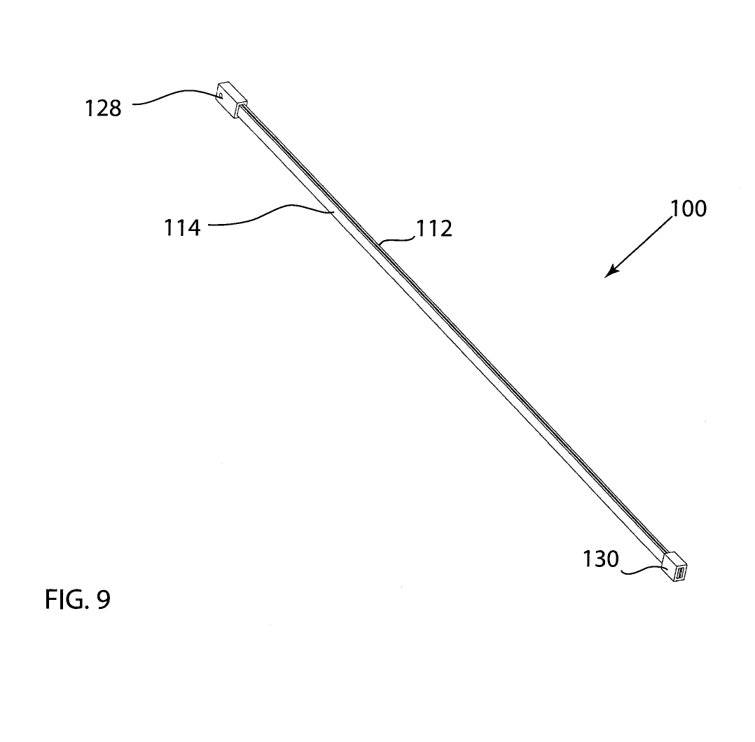

Referring now to FIGS. 8-9, another embodiment of a clamping apparatus 100 is shown. The clamping apparatus 100 includes a first clamping rail 112 and a second clamping rail 114. The clamping rails 112, 114 may be bent elongated pieces of metal or a composite material, for example, that have a relaxed tendency to be curved prior to the application of pressure. The clamping apparatus 100 further includes a first clamping assembly 128 and a second clamping assembly 130 (shown in FIG. 9). The first clamping assembly 128 and the second clamping assembly 130 are each, in this embodiment, a single component having an opening configured to receive ends of both the first clamping rail 112 and the second clamping rail 114. Two of these components 128, 130 may be configured to hold, in combination, the first and second clamping rails 112, 114 together. In one embodiment, the first clamping assembly 128 may be permanently attached to the first and second clamping rails 112, 114, as shown in FIG. 8. The second clamping assembly 130, shown in FIG. 9, may be attachable in the manner shown in FIG. 9 after objects to be clamped are placed between the clamping rails 112, 114. This embodiment, it should be understood, may be particularly useful in clamping extremely thin, hair-like objects. However, the invention should not be limited in this manner.

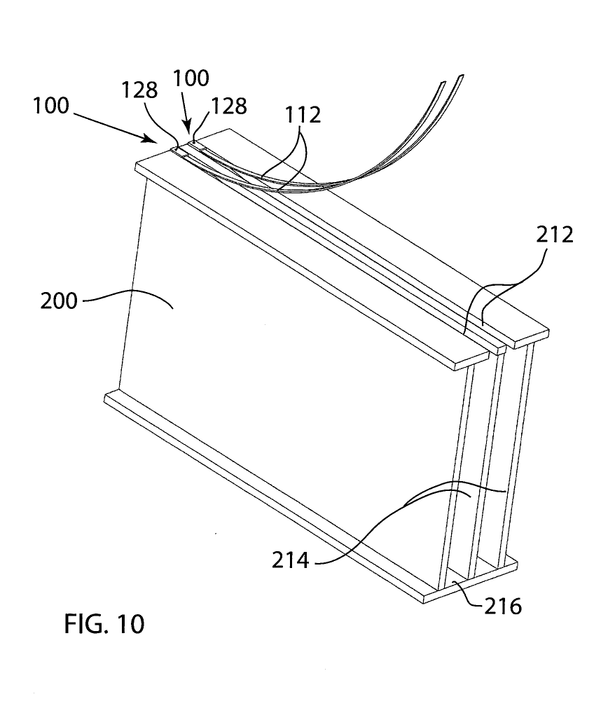

Referring now to FIG. 10, another embodiment of a clamping device 200 is shown including a base 216. The clamping device 200 may include a housing which is configured to house a plurality of the clamping apparatuses 100. In this embodiment, the clamping device housing 200 may include two slots 212 each configured to hold the clamping device 200. The object (not shown) may be configured to be laid across a top surface of the clamping device 200. The clamping device 200 may include two chambers 214 within which the bottom clamping rails (not shown) are located. The top clamping rails 112 rest above the housing of the clamping device 200 prior to clamping. Alternately, the slots 212 may actually be removed and the upper surface of the clamping device 200 may be flat. In this embodiment, no bottom clamping rails may exist. Rather, only the top clamping rails 212 may bent and then straightened such that they are brought into contact with the flat surface of the clamping device 200. Then, the second clamping component (not shown) may be attached to each of the clamping rails 212 in order to complete clamping.

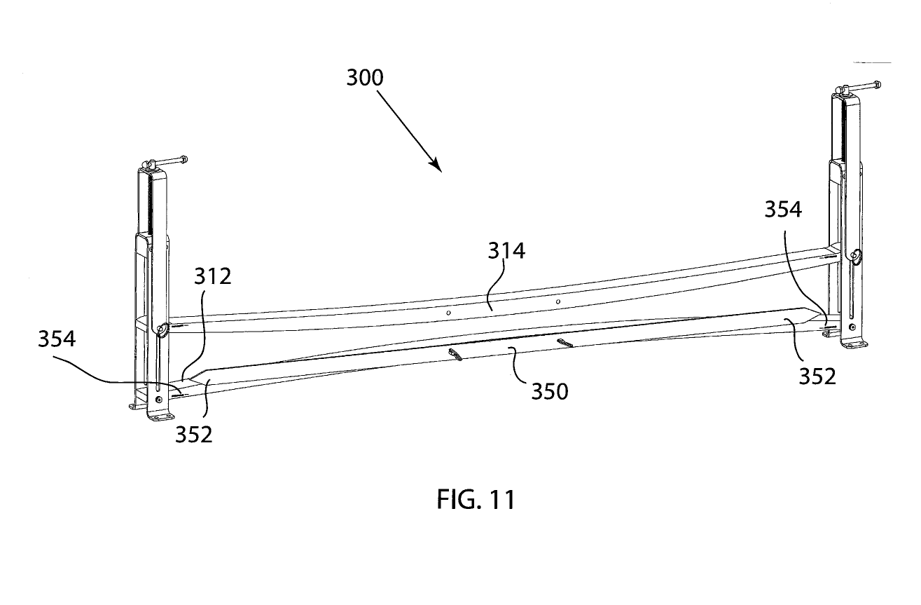

Referring now to FIG. 11, another embodiment of a clamping apparatus 300 is shown. The clamping device may be similar to the clamping apparatus 10 in all respects other than the differences outlined hereinbelow. In particular, the clamping apparatus 300 includes a load indicator 350. The load indicator 350 may include pointed ends 352. The pointed ends 352 may be configured to be located directly in between bottom and top clamping rails 312, 314 at the point where the rails 312, 314 are straightened and the load is proper. Thus, when the clamping apparatus 300 is within a close degree of the design load, the pointed ends 352 will be located at a vertical position where the clamping rails 312, 314 meet. The bottom rail 312 may further include a marking line 354. This marking line 354 may be aligned with the load indicator 350 when the midpoint of the rail 312 is lowered and the load indicator pointed end 352 moves downward to the marking rail 354. This may align the pointed end 352 of the load indicator 350 with the marking line 354 to indicate proper loading.

Further contemplated is a method of clamping. The method may include providing a first clamping rail, such as the clamping rail 112, and providing a second clamping rail, such as the second clamping rail 114, that is curved prior to clamping. The method may include straightening the second clamping rail. The method may further include clamping at least one object, such as the lumber 90, between the first clamping rail and the straightened second clamping rail. The method may include providing at least one of a substantially equal and equal pressure across a length, such as the length 32, of the at least one object with the straightened second clamping rail. The length may extend along the first and second clamping rails. The method may further include bringing ends, such as the ends 20, 22, and 24, 26, of the first clamping rail and the second clamping rail together to straighten the second clamping rail. The method may include rotating an elongated drive screw, such as the elongated drive screw 42, to straighten the clamping rail. The method may further include simultaneously straightening the first and second clamping rails. The method may further include vertically moving an outer housing component, such as the outer housing component 44, relative with an inner housing component, such as the inner housing component 46, in order straighten the second clamping rail. Moreover, the method may include moving the second clamping rail along a slot, such as the slot 40, of the inner housing component in order to straighten the second clamping rail.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. Moreover, it should be understood that the present invention may include any combination of the components, hierarchy and methodology described herein.

What is claimed is:

1. A clamping apparatus comprising:
a first clamping rail; and
a second clamping rail, wherein the second clamping rail is curved prior to clamping;
wherein the second clamping rail is straightened during clamping such that at least one of a substantially equal and an equal clamping pressure is exerted against at least one object to be clamped across a length of the first and second clamping rails.

2. The clamping apparatus of claim 1, wherein the first clamping rail has a first length extending between a first and second end and wherein the second clamping rail has a second length extending between a third end and a fourth end, and wherein a midpoint of the second clamping rail is closer to the first clamping rail and the third end and the fourth end of the second clamping rail, and wherein the first end of the first clamping rail is configured to be straightened during clamping by bringing the third end of the second clamping rail closer to the first end of the first clamping rail and bringing the fourth end of the second clamping rail closer to the second end of the first clamping rail.

3. The clamping apparatus of claim 2, further comprising:
a first clamping assembly configured to clamp the first end of the first clamping rail to the third end of the second clamping rail; and
a second clamping assembly configured to clamp the second end of the first clamping rail to the fourth end of the second clamping rail.

4. The clamping apparatus of claim 3, wherein the first clamping assembly includes a first elongated drive screw and wherein the second clamping assembly includes a second elongated drive screw.

5. The clamping apparatus of claim 3, wherein at least one of the first clamping assembly and the second clamping assembly is unfastenable from at least one of the first clamping rail and the second clamping rail.

6. The clamping apparatus of claim 1, wherein the first clamping rail is curved prior to clamping.

7. The clamping apparatus of claim 1, wherein the first clamping rail is straight prior to clamping.

8. The clamping apparatus of claim 1, further comprising a stress detector configured to display when at least one of a substantially equal and an equal clamping pressure is exerted against the at least one object by the first clamping rail and the second clamping rail.

9. The clamping apparatus of claim 3, wherein the first clamping assembly and the second clamping assembly are each a component having an opening configured to receive ends of both the first clamping rail and the second clamping rail.

10. A clamping apparatus comprising:
a first clamping rail having a first length extending between a first end and a second end; and
a second clamping rail having a second length extending between a third end and a fourth end, wherein the second clamping rail is curved prior to clamping such that a midpoint of the second clamping rail is closer to the first clamping rail than the third end and the fourth end of the second clamping rail;
wherein the first clamping rail is configured to be straightened during clamping by bringing the third end of the second clamping rail closer to the first end of the first clamping rail and bringing the fourth end of the second clamping rail closer to the second end of the first clamping rail to clamp at least one object between the first clamping rail and the second clamping rail.

11. The clamping apparatus of claim 10, further comprising:
a first clamping assembly configured to clamp the first end of the first clamping rail to the third end of the second clamping rail; and
a second clamping assembly configured to clamp the second end of the first clamping rail to the fourth end of the second clamping rail.

12. The clamping apparatus of claim 10, wherein the second clamping rail is straightened during clamping such that at least one of a substantially equal and an equal clamping pressure is exerted against the at least one object by the first clamping rail and the second clamping rail.

13. The clamping apparatus of claim 11, wherein the first clamping assembly includes a first elongated drive screw and wherein the second clamping assembly includes a second elongated drive screw.

14. The clamping apparatus of claim 11, wherein at least one of the first clamping assembly and the second clamping assembly is unfastenable from at least one of the first clamping rail and the second clamping rail.

15. The clamping apparatus of claim 10, wherein the first clamping rail is curved prior to clamping such that a midpoint of the first clamping rail is closer to the second clamping rail than the first end and the second end of the first clamping rail.

16. The clamping apparatus of claim 10, wherein the first clamping rail is straight prior to clamping.

17. The clamping apparatus of claim 10, further comprising a stress detector configured to display when at least one of a substantially equal and an equal clamping pressure is exerted against the at least one object by the first clamping rail and the second clamping rail.

18. The clamping apparatus of claim 11, wherein the first clamping assembly and the second clamping assembly are each a component having an opening configured to receive ends of both the first clamping rail and the second clamping rail.

19. A method of clamping comprising:
providing a first clamping rail;
providing a second clamping rail that is curved prior to clamping;
straightening the second clamping rail;
clamping at least one object between the first clamping rail and the straightened second clamping rail; and
providing at least one of a substantially equal and equal pressure across a length of the at least one object with the straightened second clamping rail, wherein the length extends along the first and second clamping rails.

20. The method of claim 19, further comprising bringing the ends of the first clamping rail and the second clamping rail together to straighten the second clamping rail.
